(19) United States
(12) Patent Application Publication
(10) Pub. No.: US 2012/0265778 A1
(43) Pub. Date: Oct. 18, 2012

(54) FUZZY SEARCHING IN A GEOCODING APPLICATION

(76) Inventor: LIANG CHEN, Shanghai (CN)

(21) Appl. No.: 13/088,468

(22) Filed: Apr. 18, 2011

(30) Foreign Application Priority Data
Apr. 14, 2011 (CN) 201110093834.8

(51) Int. Cl. G06F 17/30

(52) U.S. Cl. 707/765; 707/E17.014; 707/E17.018

(57) ABSTRACT

Various embodiments of systems and methods for fuzzy searching in a geocoding application are described herein. A lexical analysis is performed on an input address whose geocoding information is to be obtained to obtain portions of the input address. In one aspect, the lexical analysis may include at least one of a parsing operation, an abstraction operation, and a stretch operation. Next, a fuzzy searching is performed on a knot-sequence tree, using the portions of the input address, to identify a plurality of partial addresses which match with the input address. Next, a transposition and matching score is computed for each of the identified plurality of partial address to determine the best matching candidate for the input address. Finally, the geocoding database is queried with the best matching candidate to obtain the geocoding information of the input address.

This application claims priority under 35 U.S.C. §119 to Chinese Patent Application 201110093834.8, filed on Apr. 14, 2011, titled “FUZZY SEARCHING IN A GEOCODING APPLICATION”, which is incorporated herein by reference in its entirety.

### FIELD

Embodiments generally relate to computer systems, and more particularly to methods and systems for obtaining geocoding information of an address.

### BACKGROUND

Geocoding is generally referred to as a process of determining geographical co-ordinates (usually expressed in latitudes and longitudes) from other geographical data such as street name, postal code, etc.

Currently, geocoding is performed by searching a match for a received input address in a geocoding database that stores a plurality of addresses. In case, an exact match of the input address is found in the geocoding database a latitude/longitude pair corresponding to the input address is retrieved from the geocoding database and provided to the user.

Current geocoding technology however is imprecise and only works well when the received input address has an exact match in the geocoding database. Sub-optimal performance is encountered when one or more of the following elements is involved in the geocoding process: (1) if one of the words in the received input address is misspelled or is incorrect, For example if an address “SAINT JOHN ROAD” has been misspelled as “SANT JOHN ROAD” or is typed incorrectly as “SAINT JOHN STREET”; (2) if one of the words of the received input address can be expressed in more than one ways, For example, the word “HIGHWAY” could be expressed as “HWY”, the English word “WEST” could be expressed as “OUEST” in French; and (3) if the words of the input address can be organized in different ways, but still keeping the same meaning, For example, the address “Highway 5” could be “Highway No. 5”, or “Highway #5”, or “No. 5 Highway”.

Thus, the ability to return a more precise geocoding result from any of a variety of input data would be desirable.

### SUMMARY

Various embodiments of systems and methods for fuzzy searching in a geocoding application are described herein. A lexical analysis is performed on an input address to obtain portions of the input address. Fuzzy searching is performed on a knot-sequence tree with the obtained portions of the input address for identifying one or more of a plurality of partial addresses stored by the knot-sequence tree.

A matching and transposition score is computed for the identified plurality of partial addresses to determine a best matching candidate from among the identified plurality of partial addresses. A geocoding database is queried with the best matching candidate to obtain geocoding information related to the input address.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating a method for fuzzy searching in a geocoding application, according to an embodiment.

FIG. 2 is a block diagram illustrating one or more operations included in a lexical analysis performed on an input address, according to an embodiment.

FIG. 3 is a flow diagram illustrating a method for creating a knot-sequence tree, according to an embodiment.

FIG. 4 illustrates an exemplary reference data, according to an embodiment.

FIGS. 5A-5B illustrate creation of a knot-sequence tree using reference data of FIG. 4, according to an embodiment.

FIG. 6 illustrates an abstraction knot-sequence tree created using the reference data of FIG. 4, according to an embodiment.

FIG. 7 illustrates a method of fuzzy searching the knot-sequence tree of FIG. 5B or the abstraction knot-sequence tree of FIG. 6, according to an embodiment.

FIG. 8 is a flow diagram illustrating a method for computing a matching and transposition score for the identified plurality of partial addresses, according to an embodiment.

FIG. 9 illustrates a transposition weight table used for determining the matching and transposition score for the identified plurality of partial addresses, according to an embodiment.

FIG. 10 illustrates an exemplary code for determining a character match counter and a number of transpositions used for computing the matching and transposition score, according to an embodiment.

FIG. 11 is a flow diagram illustrating a method for re-arranging the plurality of addresses stored in the geocoding database, according to an embodiment.

FIG. 12A illustrates an exemplary geocoding database, according to an embodiment.

FIG. 12B illustrates the exemplary geocoding database of FIG. 12A storing the re-arranged plurality of addresses, according to an embodiment.

FIGS. 13A illustrates an exemplary input address whose geocoding information is to be determined, according to an embodiment.

FIGS. 13B-13C illustrate portions of the input address of FIG. 13A obtained after performing lexical analysis on the input address of FIG. 13A, according to an embodiment.

FIG. 13D illustrates a list of identified partial addresses for the input address of FIG. 13A, according to an embodiment.

FIG. 13E illustrates a portion of the reference data stored in the geocoding database, according to an embodiment.

FIG. 14 is a block diagram illustrating a computing environment in which the techniques described for fuzzy searching in a geocoding application can be implemented, according to an embodiment.

### DETAILED DESCRIPTION

Embodiments of techniques for fuzzy searching in a geocoding application are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

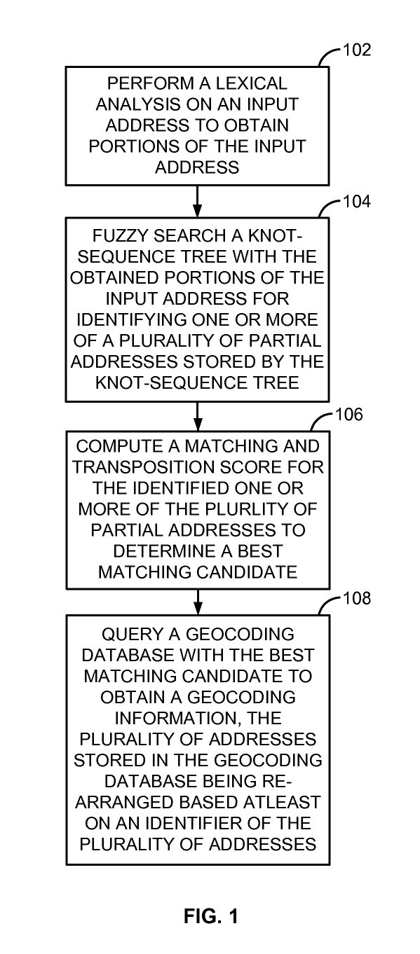

FIG. 1 is a flow diagram illustrating a method for fuzzy searching in a geocoding application, according to an embodiment. In one embodiment, the geocoding application may be used for finding geocoding information, such as geographical co-ordinates, for an input address. The input address may be received from a user. The input address may include one or more address components. For example, an input address “3, SAINT JOHN STREET, 10001” includes three address components which are: a house number address component (3), a street name address component (SAINT JOHN STREET), and a postal code address component (10001).

According to one embodiment, initially at block 102, a lexical analysis is performed on the input address. The lexical analysis includes one or more operations that are performed, either alone or in combination with each other, on one of address components of the input address to obtain portions of the input address.

In one embodiment, the lexical analysis may be defined based on the language of the input address. For example, if the input address is in English language the lexical analysis may be defined to split the input address on whitespaces, as English language has whitespaces between each word.

Next at block 104, fuzzy searching is performed on a knot-sequence tree with the portions of the input address obtained at block 102. In one embodiment, fuzzy searching, also known as approximate or inexact matching, is a searching technique that searches for text strings that approximately or substantially matches a given text string pattern. An exact match may inadvertently occur while performing the fuzzy search. Fuzzy searching may help in finding a correct match for a word even if the word is misspelled. For example, a fuzzy search for “appple” may also find “apple”. That is fuzzy search is an inexact or approximate matching technique.

In one embodiment, a knot-sequence tree is stored in a memory. The knot-sequence tree stores a plurality of partial addresses which match with the plurality of partial addresses stored in a geocoding database. In one embodiment, the partial addresses stored by the knot sequence tree are an exact match of a portion of one or more of the plurality of addresses stored in the geocoding database. The partial address is an address component of the plurality of addresses stored in the geocoding database. For example, if the address stored in the geocoding database is “3, SAINT JOHN STREET, 10001” the partial address stored in the knot-sequence tree may be the street name address component, i.e., “SAINT JOHN STREET”.

In one embodiment, fuzzy searching the knot-sequence tree with the obtained portions of the input address identifies partial addresses stored by the knot-sequence tree which may be referred to as fuzzy matches of the input address.

In one embodiment, fuzzy searching the knot-sequence tree may include comparing one or more characters of the portions of the input address with one or more characters of information stored in nodes of the knot-sequence tree to fuzzy match the portions of the input address with the information stored in the nodes of the knot-sequence tree.

Next at block 106, a matching and transposition score is computed for the partial addresses identified at block 104 for determining a best matching candidate from among the identified partial addresses. In one embodiment, the best matching candidate may be the partial address that has the highest matching and transposition score. The best matching candidate may be a best match for the input address from among the identified plurality of partial addresses. In one embodiment, more than one partial address can be identified as best matching candidate if the matching and transposition score for more than one partial address is same.

Finally at block 108, the geocoding database is queried with the best matching candidate determined at block 106 to obtain geocoding information related to the input address. In one embodiment, reference data stored in the geocoding database includes a plurality of addresses and geocoding information corresponding to the plurality of addresses. The geocoding database is queried to determine if the best matching candidate matches with at least one of the plurality of addresses in the reference data stored in the geocoding database. The geocoding information related to the address, stored in the geocoding database, matching with the best matching candidate is retrieved from the geocoding database.

In one embodiment, the plurality of addresses stored in the geocoding database has an address type and an identifier of the address type. For example, for an address “SAINT JOHN STREET”, the address type of the address is “STREET” and the identifier of the address type is “SAINT JOHN”. The addresses stored in the geocoding database are re-arranged at least based on the identifier of the address type.

In one embodiment, the fuzzy-search on the knot-sequence tree is performed with portions of the address component, i.e., partial address of the input address and the best matching candidate is determined for one of the address components of the input address. In this case, the remaining address components of the input address are merged with the best matching candidate to obtain a query. The geocoding database is then queried with the query to obtain the geocoding information related to the input address.

In the example discussed above, the fuzzy search on the knot-sequence tree may be performed with the portions of the address component “SAINT JOHN STREET” of the input address “3, SAINT JOHN STREET, 10001” to identify “SAINT JOHN ROAD” as a best matching candidate for the address component “SAINT JOHN STREET”. The remaining address components “3” and “10001” are then merged with the best matching candidate “SAINT JOHN ROAD” to obtain the query “3, SAINT JOHN ROAD, 10001”. The obtained query “3, SAINT JOHN ROAD, 10001” can then be used to query the geocoding database to obtain the geocoding information for the input address “3, SAINT JOHN STREET, 10001”.

In one embodiment the best matching candidate or the obtained query may correspond to more than one of the plurality of addresses stored in the geocoding database. In this case, the matching and transposition score is determined for each of the more than one of the plurality of addresses stored in the geocoding database. The geocoding information corresponding to the address, from among the addresses stored in the geocoding database, having the highest matching and transposition score is then determined as the geocoding information of the input address.

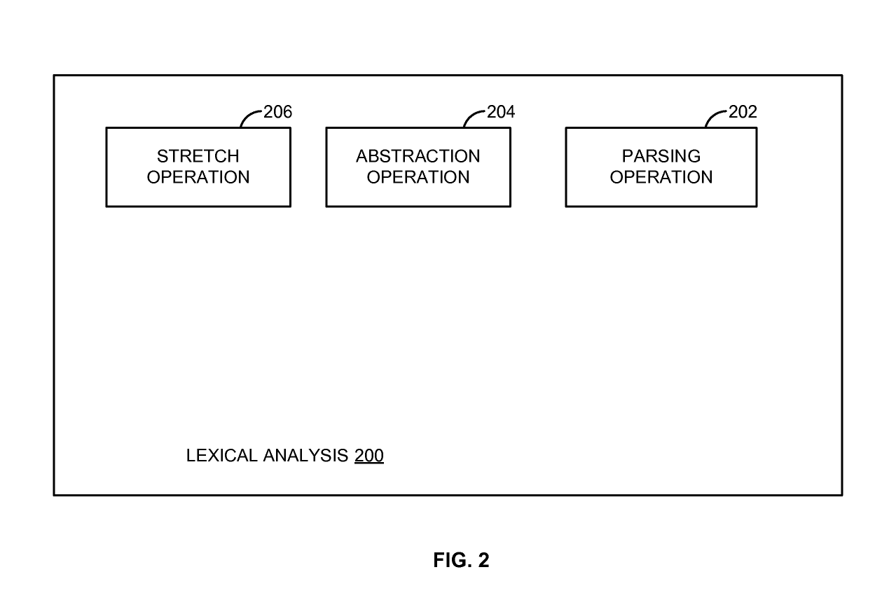

FIG. 2 is a block diagram illustrating one or more operations included in the lexical analysis 200 performed on the input address, according to an embodiment. In one embodiment, the one or more operations include a parsing operation 202, an abstraction operation 204, and a stretch operation 206. The parsing operation 202, the abstraction operation 204, and the stretch operation 206 are performed, either alone or in combination on the input address.

In one embodiment, the parsing operation 202 splits the input address to obtain portions of the input address. The parsing operation 202 may split the input address into the portions according to language of the input address. For example, if the input address is in English language the input address may be split at each white space to obtain the portions (words) of the input address. In the above example of input address “3, SAINT JOHN STREET, 10001” performing the parsing operation on the input address splits the input address at each white space to obtain five portions which are: “3”, “SAINT”, “JOHN”, “STREET”, and “10001”. If the input address is in Chinese language, the words in the input address are not separated by white space. Therefore, in case the input address is in Chinese language, the parsing operation may use a Hidden Markov Model to obtain portions of the input address.

After parsing operation splits the input address into portions, fuzzy searching is performed on the knot-sequence tree with portions of the input address to identify the partial addresses matching with the input address. In one embodiment, each of the portions of the input address is compared with the information stored in nodes of the knot-sequence tree. In the above example of “3, SAINT JOHN STREET, 10001” each of the portions “3”, “SAINT”, “JOHN”, “STREET”, and “10001” are compared with the information stored in the nodes of the knot-sequence tree.

In one embodiment, the abstraction operation 204 obtains an abstraction of the input address. A phonetic key algorithm, such as Metaphone, Double Metaphone, and Soundex, is an example of abstraction operation. The phonetic key algorithm obtains a phonetic representation, of each portion (words), of the input address which is an abstraction of the input address. Fuzzy searching is then performed on the knot-sequence tree with the abstraction of the input address to identify the partial addresses matching the input address.

In the above example of “3, SAINT JOHN STREET, 10001” if the abstraction operation performed is the phonetic key algorithm, the obtained abstraction is “3, SNT JN STRT, 10001”, where “SNT”, “JN”, and “STRT” are phonetic representation of “SAINT”, “JOHN” and “STREET”, respectively.

In one embodiment, the stretch operation 206 expands the characters of the input address according to language of the input address. The expanding of the addresses may include converting the characters in the input address to a different language. For example, a Chinese Pinyin generation is a stretch operation that translates each Chinese character in the input address into a Pinyin word in English language.

The characters in the input address are expanded by the stretch operation 206 to obtain an expanded address. Fuzzy searching is then performed on the knot-sequence tree with the expanded address to identify the partial addresses. For example, if the input address is in Chinese language the Chinese Pinyin generator obtains the expanded Pinyin address that includes the Pinyin word for each Chinese character in the input address.

In one embodiment, the parsing operation 202, the abstraction operation 204, and the stretch operation 206 are performed in combination with each other. For example, initially the Chinese Pinyin generator (stretch operation 206) can be applied on the input address in Chinese language to obtain the expanded Pinyin address, a parsing operation 202 can then be applied on the expanded Pinyin address to obtain portions of the expanded Pinyin address. The fuzzy search may then be performed on the knot-sequence tree with the obtained portions of the expanded Pinyin addresses to identify the partial addresses for the input address.

In another example, the parsing operation 202 may be applied initially on the input address to obtain portions of the input address and then the abstraction operation 204 may be performed on the obtained portions. In the above example, the input address “3, SAINT JOHN STREET, 10001” may be first split into five portions, which are “3”, “SAINT”, “JOHN”,“STREET”, and “10001” by applying the parsing operation 202. The phonetic key algorithm, abstraction operation 204, can then be applied on the obtained portions to obtain phonetic key representing each of the obtained portions, i.e., “3”, “SNT”, “JN”, “STRT”, and 10001. A fuzzy searching can then be performed on the knot-sequence tree with the abstraction of each of the portions of the input address to identify the plurality of partial addresses for the input address.

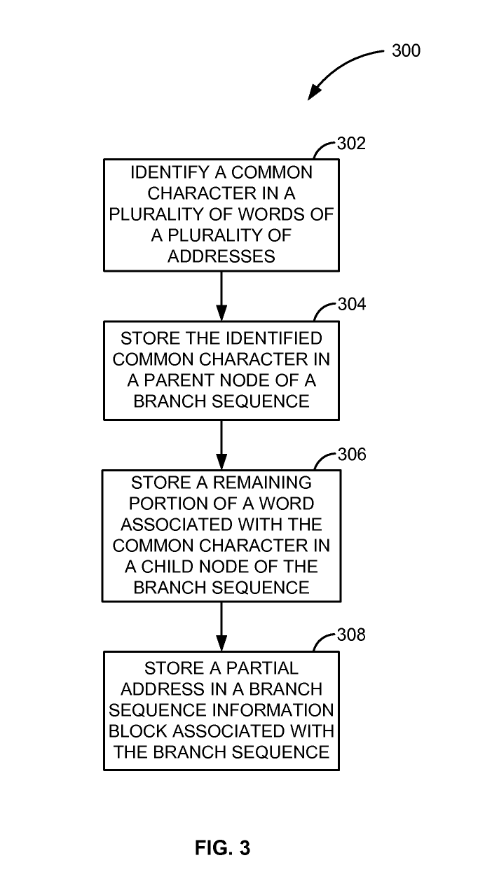

FIG. 3 is a flow diagram 300 illustrating a method for creating the knot-sequence tree, according to an embodiment. In one embodiment, the knot-sequence tree is created during design time. The knot-sequence tree is created using the plurality of addresses, included in the reference data, stored in the geocoding database. In one embodiment, the knot-sequence tree is created using the partial addresses. The knot-sequence tree stores the partial addresses in a memory.

As shown, initially at block 302 a common character is identified in the words of the addresses stored in the geocoding database. In one embodiment, the geocoding database is searched to identify the common character in the words of the partial addresses stored in the geocoding database. The common characters in the words of the addresses stored in the geocoding database are identified. For example, if one of the words in the addresses is “MAIN” and another word in the addresses is “MARY” then the common character identified is “MA”.

In one embodiment, a portion of the addresses are searched to identify the common character in its words. For example, the street name address component of the addresses stored in the geocoding database may be searched for identifying the common character in the words of the street name address components.

In one embodiment, the common character identified is stored in a parent node of the knot-sequence tree. The common character identified is information stored in a parent node of the knot-sequence tree, which is compared with the portions of the input address during the fuzzy searching of the knot-sequence tree.

Next at block 304, the common character identified at block 302 is stored in a parent node of the knot-sequence tree. In one embodiment, the common character is stored in the parent node of a branch sequence of the knot-sequence tree. In one embodiment, the knot-sequence tree includes one or more parent nodes each storing one of the common characters identified at block 302. In the above example, of “MAIN” and “MARY” the identified common character “MA” is stored in the parent node of the knot-sequence tree.

In one embodiment, the knot-sequence tree includes the branch sequence. The branch sequence may include one or more nodes connected by a branch that indicates a direction for traversing the branch sequence. In one embodiment, the combination of information stored in the nodes of the branch sequence may identify one or more partial addresses stored in the knot-sequence tree. The parent node is a root node of the branch sequence. In one embodiment, the parent node is the root node of one or more branch sequences.

Next at block 306 a remaining portion of a word, from among the plurality of words, associated with the common character identified at block 302 is stored in a child node of the branch sequence. The parent node and the child node may be connected by the branch which indicates the direction for traversing the branch sequence. In the above example, the remaining portions of the words “MAIN” and “MARY” are “IN” and “RY”, respectively. The remaining portions “IN” and “RY” are stored in separate child nodes and are connected to the parent node, with separate branches, storing the common one or more characters “MA” with branches.

In one embodiment, if the common character is associated with only one word in the addresses then the remaining portion is stored in the parent node.

Finally at block 308, the addresses are stored in one or more sequence information blocks associated with the branch sequence. In one embodiment, the partial addresses are stored in one or more sequence information blocks associated with the branch sequence. In one embodiment, the sequence information block associated with the branch sequence stores a partial address containing the common character stored in the parent node of the branch sequence or a combination of the common character and the remaining portion stored in the parent node and the child node of the branch sequence. For example, a partial address “STREET MAIN, 10001” is stored in a sequence information block associated with a branch sequence whose parent node stores “MA”.

In one embodiment, the sequence information block may be associated with more than one branch sequence. For example, a sequence information block storing “SAINT JOHN STREET” may be associated with a first sequence information block whose parent node stores “SAINT”, a second information block whose parent node stores “JOHN”, and a third sequence information block whose parent node stores “STREET”.

In one embodiment, the sequence information block refers to another sequence information block from among the one or more sequence information blocks of the knot-sequence tree. A portion of the partial address stored in another sequence information block is related to a portion of the partial address stored in the sequence information block. For example, a sequence information block storing an address “West Street” may refer to another sequence information block storing an address “Ouest Road”. The portion “Ouest” stored in the another sequence information block of the address “Quest Road” is related to the portion “West” of the address “West Street” stored in the sequence information block.

In one embodiment, if the identified partial address is stored in the sequence information block that refers to another sequence information block, then the partial address stored in the another sequence information block is considered as an identified partial address.

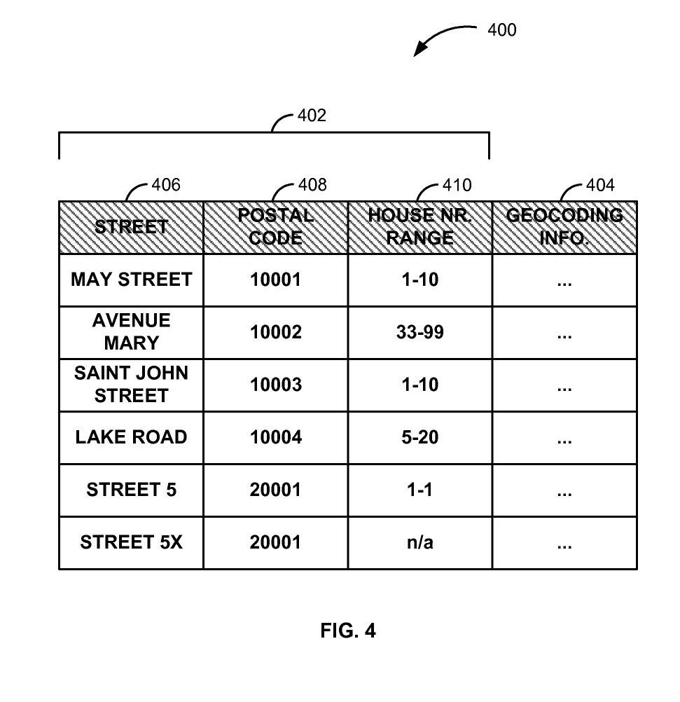

FIG. 4 illustrates an exemplary reference data 400, according to an embodiment. As discussed above, the reference data may be stored in the geocoding database. As shown, the reference data, stored in the geocoding database, includes a plurality of addresses 402 and a geocoding information 404 corresponding to the addresses 402. In one embodiment, the addresses 402 include a street name address component 406, a postal code address component 408, and a house number range address component 410.

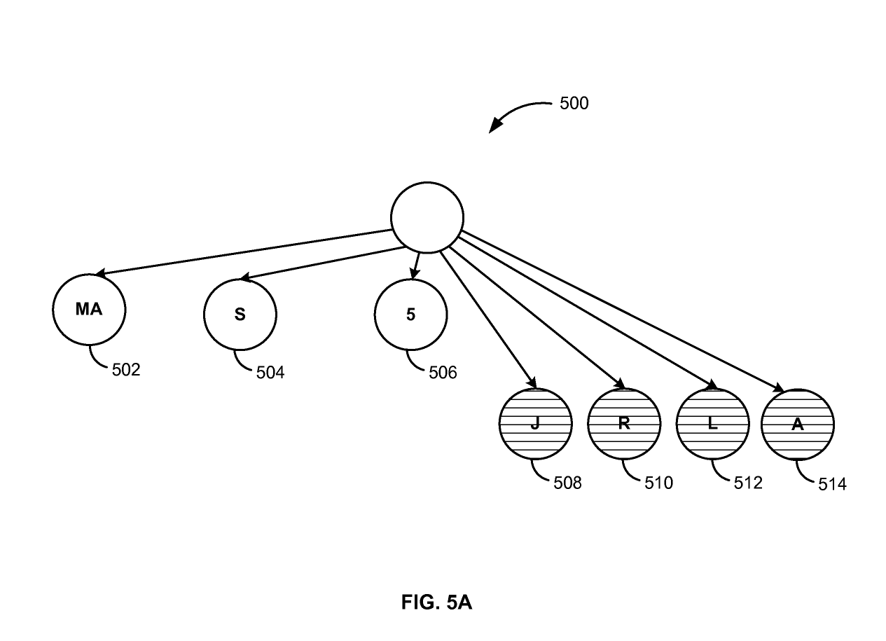

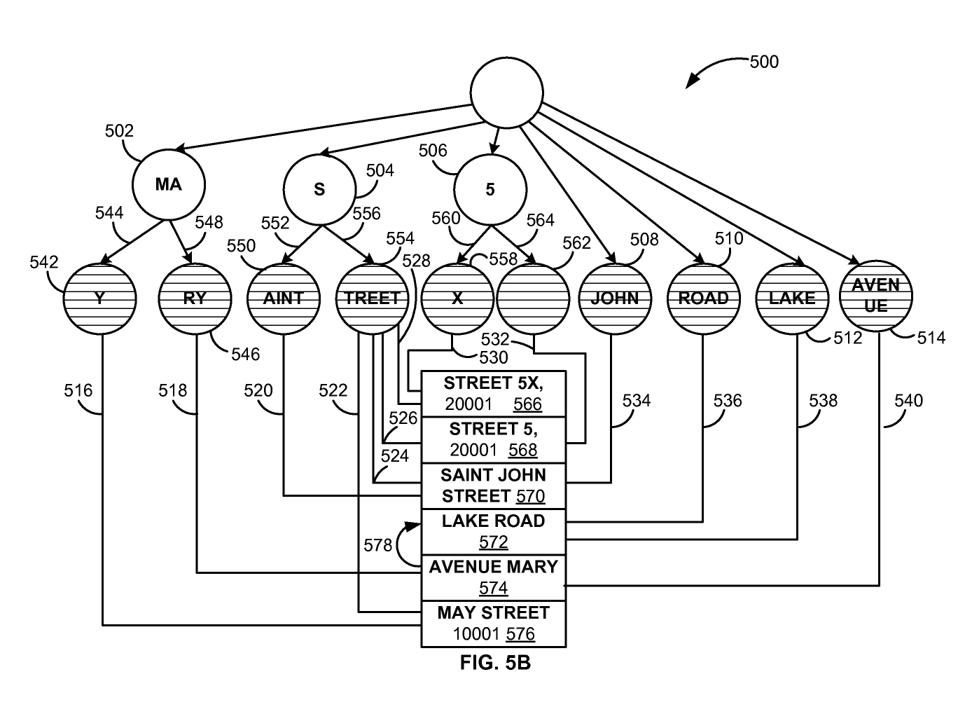

FIGS. 5A-5B illustrate the creation of a knot-sequence tree 500 using the reference data 400 of FIG. 4, according to an embodiment. The knot-sequence tree 500 is created using partial addresses, i.e., the street name address component 406 of the addresses 402 of FIG. 4. In one embodiment, the knot-sequence tree 500 is created using the street name address component 406 when the fuzzy search on the knot-sequence tree is to be performed on the street name address component 406.

Initially, the common character in the plurality of words, i.e., “MAY”, “STREET”, “AVENUE”, “MARY”, “SAINT”, “JOHN”, “LAKE”, “ROAD”, “5”, and “5X” in the street name address component 406 are identified. As shown in FIG. 5A, the common character identified are: “MA” which corresponds to the words “MAY” and “MARY” in the street address component; “S” which corresponds to “SAINT” and “STREET” in the street address component; “5” which corresponds to “5” and “5X” in the street address component; “J” which corresponds to “JOHN” in the street address component; “R” which corresponds to “ROAD” in the street address component; “L” which corresponds to the word “LAKE”; and “A” which corresponds to “AVENUE” in the street address component.

Next as shown in FIG. 5A, each of the identified common character “MA”, “S”, “5”, “J”, “R”, “L” and “A” are stored respectively in parent nodes 502, 504, 506, 508, 510, 512, and 514, respectively. In one embodiment, the identified common character in the parent nodes is the information stored in the parent nodes. As shown in FIG. 5B, the parent node 502 is the root node of branch sequences 516 and 518, the parent node 504 is the root node of the branch sequences 520-528, the parent node 506 is the root node of the branch sequences 530 and 532, the parent node 508 is the root node of the branch sequence 534, the parent node 510 is the root node of the branch sequence 536, the parent node 512 is the root node of the branch sequence 538, and the parent node 514 is the root node of the branch sequence 540.

Next the remaining portion of the word “MAY”, i.e., “Y” associated with the common character “MA” stored in the parent node 502 is stored in a child node 542 of the branch sequence 516. The parent node 502 and the child node 542 are connected by a branch 544 that indicates the direction for traversing the branch sequence 516, i.e., if a fuzzy searching is performed on the knot-sequence tree 500 the information stored in the parent node 502 is searched first and then the information stored in the child node 542 is searched.

The remaining portion of the word “MARY”, i.e., “RY” associated with the common character “MA” stored in the parent node 502 is stored in a child node 546 of the branch sequence 518. The parent node 502 and the child node 546 are connected by a branch 548 that indicates the direction for traversing the branch sequence 518.

The remaining portion of the word “SAINT”, i.e., “AINT” associated with the common character “S” stored in the parent node 504 is stored in a child node 550 of the branch sequence 520. The parent node 504 and the child node 550 are connected by a branch 552 that indicates the direction for traversing the branch sequence 520. The remaining portion of the word “STREET”, i.e., “TREET” associated with the common character “S” stored in the parent node 504 is stored in a child node 554 of the branch sequences 522-528. The parent node 504 and the child node 554 are connected by a branch 556.

The remaining portion of the word “5X”, i.e., “X”, associated with the common character “5” stored in the parent node 506, is stored in a child node 558 of the branch sequence 530. The parent node 506 and the child node 558 are connected by a branch 560 that indicates the direction for traversing the branch sequence 530. The parent node 506 is also connected with a child node 562 by a branch 564 that indicates the direction for traversing the branch sequence 532.

Further, the common one or more characters J, R, L, and A, stored in parent nodes 508, 510, 512, and 514, respectively, correspond to only one word of the plurality of words in the street name address component 406, i.e., “JOHN”, “ROAD”, “LAKE” and “AVENUE”, respectively. Therefore, the remaining portions “OHN”, “OAD”, “AKE” and “VENUE” corresponding to the common character J, R, L, and A, respectively, are stored in the parent nodes 508, 510, 512, and 514, respectively, along with the common character.

In one embodiment, the knot-sequence tree 500 includes sequence information blocks which store the plurality of partial addresses. A sequence information block may be associated with one or more branch sequences. In one embodiment, the information stored in the parent node and the child node of the branch sequence identifies the partial address stored in the sequence information block associated with the branch sequence. As shown, the branch sequence information block 566 stores the partial address “STREET 5X, 20001”. The branch sequence information block 566 is associated with the branch sequences 528 and 530. The parent and child node respectively 506 and 558 of the branch sequence 530 store “5X” which identifies the partial address “STREET 5X, 20001” stored in the branch sequence information block 566 associated with the branch sequence 530. The parent node and the child node respectively 504 and 554 of the branch sequence 528 store “STREET” which also identifies the partial address “STREET 5X, 20001” stored in the branch sequence information block 566 associated with the branch sequence 528.

Similarly, the branch sequence information block 568 stores the partial address “STREET 5, 20001” and is associated with the branch sequences 526 and 532. The branch sequence information block 570 stores the partial address “SAINT JOHN STREET” and is associated with the branch sequences 524 and 534. The branch sequence information block 572 stores the partial address “LAKE ROAD” and is associated with the branch sequences 536 and 538. The branch sequence information block 574 stores the partial address “AVENUE MARY” and is associated with the branch sequences 518 and 540. The branch sequence information block 576 stores the partial address “MAY STREET 10001” and is associated with the branch sequences 516 and 522.

In one embodiment, the branch sequence information block 574 refers to another branch sequence information block 572 as indicated by arrow 578. The portion “ROAD” of the partial address “LAKE ROAD” stored in the another branch sequence information block 572 is related to the portion “AVENUE” of the partial address “AVENUE MARY” stored in the sequence information block 574.

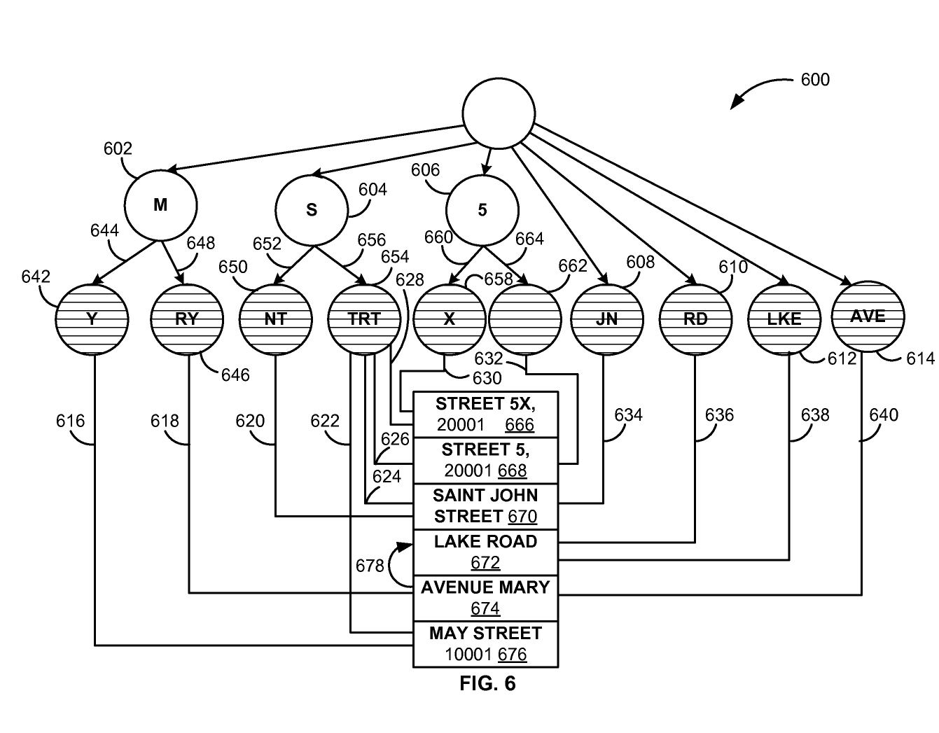

FIG. 6 illustrates an abstraction knot-sequence tree 600 created using the reference data of FIG. 4, according to an embodiment. In one embodiment, the abstraction knot-sequence tree 600 is created at design time and stored in the memory. In one embodiment, the parent nodes of the abstraction knot-sequence tree 600 store an abstraction of the common character in the words of the street name address components 406. The child nodes of the abstraction knot-sequence tree stores an abstraction of the remaining portion of the word associated with the common character stored in the parent node.

As discussed above with respect to FIGS. 5A-5B the common character identified for the plurality of words in the street name address component are “MA”, “S”, “5”, “J”, “R”, “L”, and “A”. In one embodiment, if the common character is associated with more than one word the abstraction of the common character is obtained. Further, if the common character is associated with only one word the abstraction of the word is obtained. As discussed above, the common character that relates to more than one word are “MA”, “S”, and 5. The abstraction of the common character MA” is “M”, the abstraction of the common character “S” and “5” is same as the input, i.e., “S” and 5, respectively. As shown, the obtained abstraction “M” is stored in parent node 602 of the branch sequence 616. The obtained abstraction “S” is stored in the parent node 604 of the branch sequences 620-628. The obtained abstraction “5” is stored in the parent node 606 of the branch sequences 630 and 632.

The common character “J”, “R”, “L” and “A” are associated with only one word which is “JOHN”, “ROAD”, “LAKE”, and “AVENUE”, respectively. The abstraction of the word “JOHN”, “ROAD”, “LAKE”, and “AVENUE” are “JN”, “RD”, “LKE”, and AVE”, respectively. The abstraction of the word “JOHN”, i.e., “JN” is stored in the parent node 608 of the branch sequence 634, the abstraction of the word “ROAD”, i.e., “RD” is stored in the parent node 610 of the branch sequence 636, the abstraction of the word “LAKE”, i.e., “LKE” is stored in the parent node 612 of the branch sequence 638, and the abstraction of the word “AVENUE”, i.e., “AVE” is stored in the parent node 614 of the branch sequence 640.

Next, the abstraction of the remaining portion of the word associated with the common character is obtained. The remaining portions associated with the common character “MA” are “Y” and “RY”, respectively. The abstraction of the remaining portion “Y” and “RY” is same as input, i.e., Y and RY, respectively. The abstraction of the remaining portion “Y” and “RY” is stored in the child node 642 and 646 of the branch sequence 616 and 618, respectively.

The remaining portion of the common character “S”, stored in the parent node 604 are “AINT” and “TREET”. The abstraction of the remaining portion “AINT” is “NT” which is stored in the child node 650 of the branch sequence. The abstraction of the remaining portion “TREET” is “TRT” which is stored in the child node 654. The remaining portion of the word associated with the common character “5” is “X”. The abstraction of the remaining portion “X”, is same as input i.e. “X”, which is stored in the child node 658 of the branch sequence 630.

The branches 644, 648, 652, 656, 660 and 664 have similar features as the branches 544, 548, 552, 556, 560 and 564 of FIG. 5B. The branch sequence information blocks 666-676 have similar features as the branch sequence information blocks 566-576 of FIG. 5B.

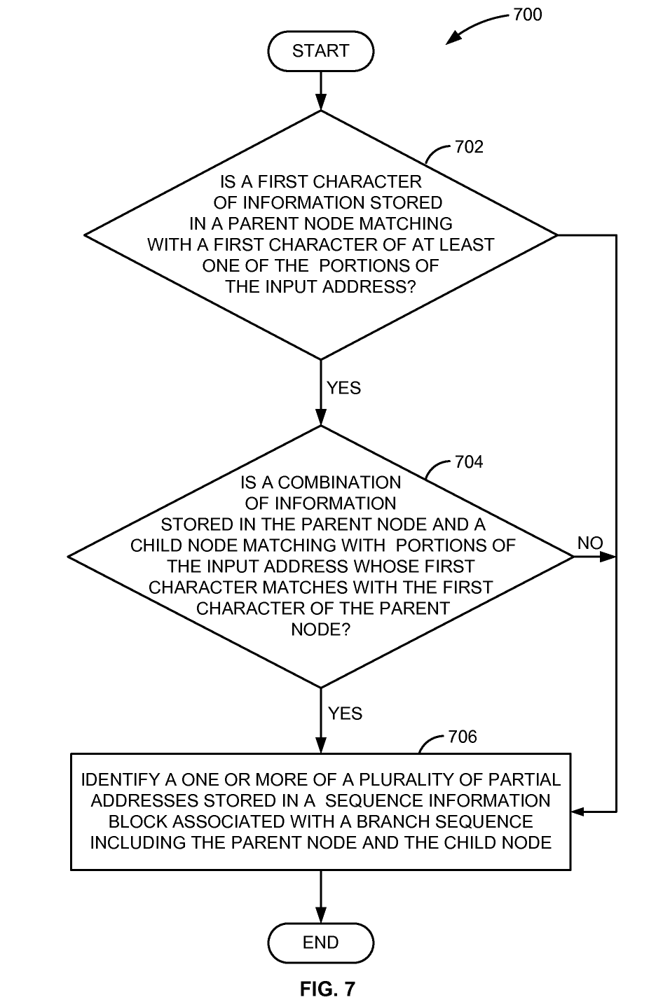

FIG. 7 illustrates a method 700 of fuzzy searching the knot-sequence tree 500 of FIG. 5B or the abstraction knot-sequence tree 600 of FIG. 6, according to an embodiment.

Initially at block 702, a check is performed to determine if the first character of the information stored in the parent node of the knot-sequence tree matches with the first character of portions of the input address. In one embodiment, the check is performed to determine if the first character of at least one of the portions of the input address matches with the information stored in the parent node of the knot-sequence tree. As discussed above, the common character, in each word of the plurality of address stored in the geocoding database, is the information stored in the parent node. In one embodiment, the check is performed to determine if the common character stored in the parent node of the knot-sequence tree matches with the first character of each of the portions of the input address.

In one embodiment, the abstraction of each of the portions of the input address is obtained. For example, a phonetic representation of each of the portions of the input address is obtained. A check is then performed to determine if the first character of the abstraction of each of the portions of the input address matches with the first character of the information stored in the parent node of the abstraction knot-sequence tree.

In one embodiment, an abstraction of the portions of the input address and the information stored in the parent node of the knot-sequence tree is determined and then the check is performed to determine if the first character of the abstraction of information stored in the parent node matches with the first character of abstraction of portions of the input address. For example, if the input address is “SAINT JOHN STREET”, the portions of the input address are “SAINT”, “JOHN”, and “STREET”. The abstraction of the portions of the input address are “SNT”, “JN”, and “STRT”. Each of these abstractions, i.e., “SNT”, “JN”, and “STRT” are compared with the abstraction of the information stored in the parent node of the knot-sequence tree or the information stored in the parent node of the abstract knot-sequence tree.

In case the first character of information stored in the parent node matches with the first character of at least one of the portions of the input address, i.e. if the condition in block 702 is true, then a check is performed to determine if a combination of information stored in the parent node and a child node matches with portions of the input address (block 704). In one embodiment, the check is performed to determine if the combination of information stored in the parent node and the child node matches with that portion of the input address whose first character matches with the first character of the information stored in the parent node at block 702. In one embodiment, the combination of information is obtained between the parent node and each of the child nodes connected to the parent node by the branch. In one embodiment, the combination of information is obtained between the child node of the branch sequence, whose root node is the parent node, and the parent node. In one embodiment, an abstraction of the combination of information stored in the parent node and the child node is obtained and the abstraction of the combination of information is compared with the abstraction of portions of the input address.

Finally at block 706, if the combination of information stored in the parent node and the child node of the branch sequence matches with at least one of the portions of the input address then the partial address stored in the sequence information block associated with the branch sequence is identified.

In one embodiment, the identified partial addresses are retrieved from the memory for calculating the matching and transposition score.

In one embodiment, if the sequence information block storing one of the identified partial address refers to another sequence information block then the partial address stored in the another sequence information block is also considered as an identified partial address.

Next a matching and transposition score is computed for the identified plurality of partial addresses.

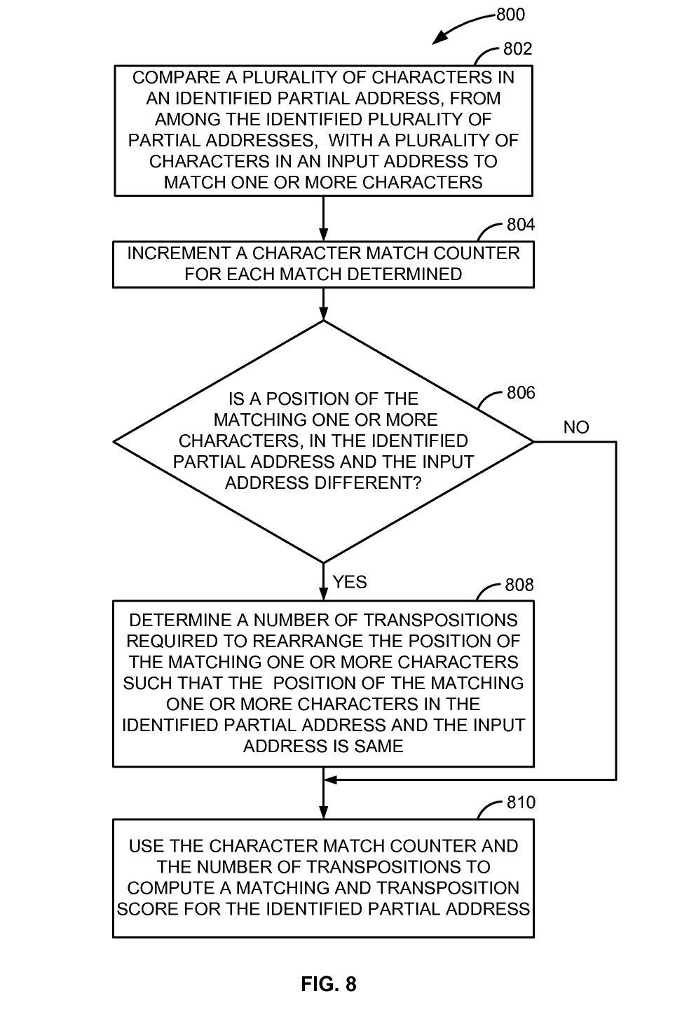

FIG. 8 is a flow diagram 800 illustrating a method for computing the matching and transposition score for the identified plurality of partial addresses, according to an embodiment. In one embodiment, the matching and transposition score is computed for each of the plurality of partial addresses identified by fuzzy searching the knot-sequence tree. In one embodiment, the matching and transposition score determines the best matching candidate from among the identified plurality of partial addresses.

Initially at block 802, an identified partial address, from among the identified plurality of partial addresses, is compared with the input address. In one embodiment, each of the identified partial addresses is compared with the input address to compute the matching and transposition score for each of the identified partial addresses.

In one embodiment, comparing the identified partial address with the input address includes comparing characters in the identified partial address with characters in the input address. In one embodiment, each of the characters in the identified partial address is compared with each of the characters in the input address. The characters in the identified partial address are compared with the characters in the input address to match one or more characters which are common in the identified partial addresses and the input address.

In one embodiment, the characters in the identified partial address are compared sequentially with the characters in the input address. For example, if the input address is “SAINT JOHN” and the identified partial address for “SAINT JOHN” is “SAINT MARK AVENUE”, initially the first character “S” of “SAINT JOHN” is compared with all the characters of “SAINT MARK AVENUE”, next the second character “A” of “SAINT JOHN” is compared with all the characters of “SAINT MARK AVENUE”. Similarly each of the character of “SAINT JOHN” is sequentially compared with all the characters of “SAINT MARK AVENUE”. The matching one or more characters in this example is “SAINT” which is common in both “SAINT JOHN” and “SAINT MARK AVENUE”.

In one embodiment, after completing the comparison between the characters in the identified partial address with the characters in the input address, the matching characters are removed from both the identified partial address and the input address to obtain a remaining portion of the identified partial addresses and a remaining portion of the input address. The characters in the remaining portion of the identified partial address are then compared with the characters in the remaining portion of the input address to match characters in the remaining portion of the identified partial address and the remaining portion of the input address.

Next at block 804 a character match counter is incremented for each match determined at block 802. In one embodiment, the character match counter is equal to the number of matching characters. The character match counter may be set to zero initially. In the above example of “SAINT JOHN” and “SAINT MARK AVENUE” the value of the character match counter is 5 as the character match counter is incremented five times for each of the matching characters “S”, “A”, “I”, “N” and “T”, respectively.

In one embodiment, a determination is made whether the number of matching one or more characters which are positioned adjacent to each other is greater than a predetermined minimum number of matching one or more characters positioned adjacent to each other (M). In one embodiment, the character match counter is incremented only if the number of matching one or characters which are positioned adjacent to each other is greater than M. For example, if the input address is “SAINT JOHN” and the identified partial address is “SAINT POPE”, then the number of matching characters is 6, i.e., “S”, “A”, “I”, “N”, “T”, and “O”. However, the number of matching characters which are positioned adjacent to each other is 5, i.e., “S”, “A”, “I”, “N”, and “T”. This number (5), should be greater than M, otherwise the character main counter for the identified partial address “SAINT POPE” is 0.

Next at block 806, a check is performed to determine whether a position of the matching one or more characters in the identified partial address and the input address is different. In one embodiment, the check is performed to determine if the position of the matching one or more characters in the identified partial address and the input address are transposed, i.e., interchanged.

In one embodiment, the matching characters include a first set of matching characters which are positioned adjacent to each other and a second set of matching characters positioned adjacent to each other. In one embodiment, the matching characters are transposed, if the position of the first set of the matching characters and the second set of matching characters, in the one of the identified partial addresses and the input address, is interchanged. Consider an example of an input address “STREET MAIN” and an identified partial address “MAIN STREET”. The matching one or more characters in “STREET MAIN” and “MAIN STREET” are “STREET” and “MAIN.” The first set of matching one or more characters positioned adjacent to each other is “STREET” and the second set of matching one or more characters positioned adjacent to each other is “MAIN”. The position of the first set of matching one or more characters, i.e., “STREET” and the second set of matching one or more characters, i.e., “MAIN”, in “STREET MAIN” and “MAIN STREET”, is interchanged. Therefore, the input address “STREET MAIN” is a transposition of the identified one of the plurality of partial addresses “MAIN STREET.”

Next if the condition in block 806 is true, a number of transpositions is determined in block 808. In one embodiment, the number of transpositions is the transpositions required to re-arrange the position of the matching one or more characters such that the position of the matching one or more characters in the identified partial address and the input address is same. In the above example of “STREET MAIN” and “MAIN STREET” the number of transpositions required is 1 as 1 transition is required to change the position of “STREET” and “MAIN” in “STREET MAIN” to “MAIN STREET.”

In one embodiment, if the condition in block 806 is false the number of transpositions is zero. In one embodiment, a function transposition_gestalt is defined that returns the character match counter and the number of transpositions for the identified partial address.

Finally at block 810, the character match counter and the number of transpositions determined at block 804, and 808, respectively are used for computing the matching and transposition score for the identified partial address. In one embodiment, the process described in blocks 802-810 is performed for each of the identified plurality of partial addresses to compute the matching and transposition score for each of the plurality of partial addresses. In one embodiment, the partial address from among the identified plurality of partial addresses, having the highest matching and transposition score is determined as the best matching candidate. The geocoding database is finally queried with the best matching candidate to obtain geocoding information related to the input address.

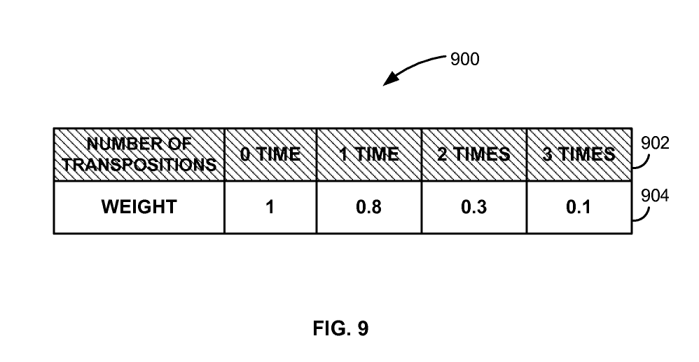

FIG. 9 illustrates a transposition weight table 900 used for determining the matching and transposition score for the identified partial address, according to an embodiment. The transposition weight table 900 includes two rows storing a number of transpositions 902 and a weight 904 corresponding to the number of transpositions. The transposition weight table 900 assigns a weight corresponding to the number of transpositions. As shown, if the number of transpositions 902 is 0 the weight 904 assigned is 1, if the number of transpositions 902 is 1 the weight 904 assigned in 0.8. If the number of transpositions 902 is 2 the weight 904 assigned is 0.3, and if the number of transpositions 902 is 3 the weight 904 assigned is 0.1.

In one embodiment, the matching and transposition score is calculated using a matching and transposition score formula:

$$matching and transposition score = \frac{2 \times {\sum }_{i = 0}^{ret [ 0 ]} weigh [ i ] \times ret [ 1 ] [ i ]}{length ( A ) + length ( B )}$$

Where weight [i] is the weight corresponding to the number of transpositions for the identified partial address obtained from the transposition weight table;

ret [l] [i] is the value of the character match counter for the i^{th} number of transposition;

string A and string B refer to the identified partial address and the input address, respectively;

length (A) and length (B) refers to a number of characters in the identified partial address and the input address, respectively; and

i is the number of transpositions.

The matching and transposition score formula sums the product of the weight corresponding to a particular number of transpositions and the value of the character match counter corresponding to the particular number of transpositions. The obtained sum is multiplied by 2. Finally, the obtained product is divided by the sum of the number of characters in the identified partial address and the input address to obtain the matching and transposition score.

In one embodiment, the matching and transposition score for the partial address stored in the other sequence information block, referenced by the sequence information block that stores the identified partial address, is computed. In this case, the portion of the partial address, stored in the another sequence information block, which relates the partial address to the identified partial address is removed from both the partial address and the input address before calculating the transposition and matching score for the partial address.

Consider an example of an input address “ST MARY” for which the best matching candidate is to be determined. The identified partial address, from the knot-sequence tree, for the input address “ST MARY” is “ST JOHN” and “AVENUE MARY”. A partial address “MAY STREET” is stored in another sequence information block referenced by the information block storing the identified partial address “ST JOHN”. The portion “STREET” in the partial address “MAY STREET” relates the partial address “MAY STREET” with the partial address “ST JOHN”. As “STREET” is an alias for “ST” the matching and transposition score for “MAY STREET” is calculated by substituting “ST” in the input address with “STREET.” The matching and transposition score computed for “AVENE MARY”, “ST JOHN”, and “MAY STREET” is 0.556, 0.429, and 0.571, respectively.

As can be seen the transposition and matching score for the input sequence “MAY STREET” obtained from the related sequence information block is highest. However, the transposition and matching score for “MAY STREET” is highest only due to the portion “STREET” of the address “MAY STREET” which is not a part of the input address “ST MARY”. As the matching and transposition score value for “MAY STREET” is increased due to the word “STREET” the matching and transposition score is re-calculated after removing “ST” and “STREET” from the input address “ST MARY” and the partial address “MAY STREET” stored in the another sequence information block. The matching and the transposition score computed for “MAY”, obtained after removing “STREET” from the partial address “MAY STREET”, is 0.444.

Finally, the transposition and matching score for the partial addresses “AVENUE MARY”, “ST JOHN” and “MAY STREET” are evaluated again and the partial address “AVENUE MARY” which has the highest matching and transposition score is determined as the best matching candidate for querying the geocoding database.

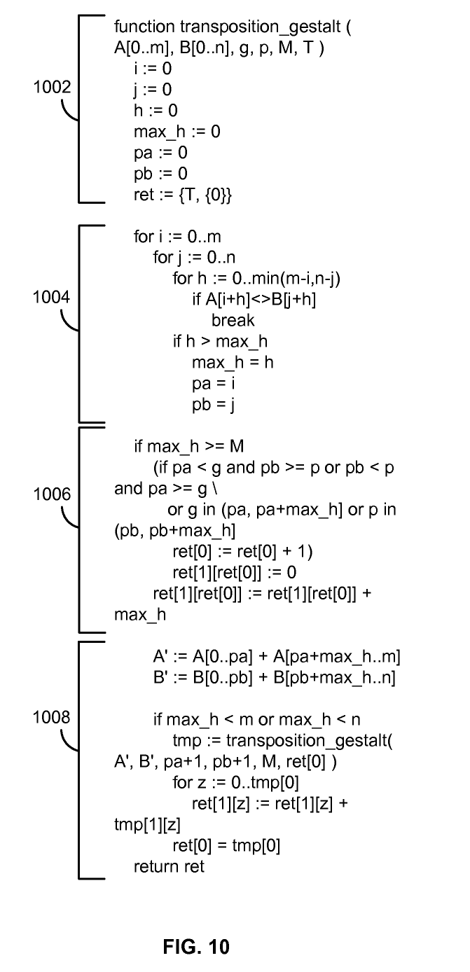

FIG. 10 illustrates an exemplary code for determining the character match counter and the transposition counter for computing the matching and transposition score, according to an embodiment. As shown in FIG. 10, the code has been split into four parts 1002, 1004, 1006, and 1008 for explaining the functionality of the code.

Initially, in portion 1002 of the code a transposition_gestalt function is defined, which has as input a first string A that has m+1 characters, a second string B that has n+1 characters, variables g and p which are used to identify whether the matching one or more characters are transposed in string A and string B, M which denotes a minimum number of matching one or more characters positioned adjacent to each other, T which represents the number of transpositions, and variable ret which returns a nested list, which has a number of transposition as the first element and the character match counter for each number of transpositions as its followings elements. In one embodiment, the string A is the input address and the second string B is the identified partial address for the input address.

A plurality of variables i, j, h, max_h, pa, and pb are set to zero. The variables i, j, and h are iterators, max_h stores a maximum value of h, and pa and pb are pointers to the string A and the string B, respectively. As shown, in portion 1004 of the code nested loops are used for determining the number of one or more characters matching (character match counter (max_h)) in the string A and the string B. The innermost loop h has a condition “if A[i+h]<>B[j+h]”, which sequentially compares each character of the first string with all the characters of the second string. If the condition is not satisfied a break condition stops the execution of the innermost loop.

Consider an example of the first string A “STREET MAIN” that has 11 characters (m=10) and the second string B “MAIN STREET” that has 11 characters (n=10). The minimum number of matching one or more characters positioned adjacent to each other (M) is set as 3.

The first time the inner loop h is executed the first character “S” (A[0]) of string A is compared with the first character “M” (B[0]) of string B. As, “S” and “M” do not match the inner most loop h breaks, next the value of the iterator j is incremented to 1, the second time the inner loop h is executed the first character “S” (A[0]) is compared with the second character “A” (B[1]) of string B. This process continues till the inner loop h is executed for the sixth time. At this instance, the value of j is 5 and the first character “S” (A [0]) of string A matches with the sixth character “S” (B [5]) of string B. The value of the character match counter (h) is incremented by 1. As the condition A[i+h]<>B[j+h] is not satisfied the inner most loop h does not break. Next, the inner most loop is again executed. In this instance, the second character “T” (A[1]) of the first string A matches with the seventh character “T” (B[6]) of the second string B. Each time the innermost loop is executed the value of the iterator h is incremented by 1. This process continues till the sixth character “T” (A[5]) matches with the last character “T” (B[10]) of the second string B. At this instance, the value of the iterator h is 6 which is assigned to the character match counter (max_h). As no transposition has been determined, the value of the character match counter (max_h) is 6 when the number of transposition is 0. The pointer pa of A stores the position of the first matching character of string A, i.e., 0 and the pointer pb of B stores the position of the first matching character of the string B, i.e., 5.

Next, the portion 1006 of the code determines if the matching characters in the first string A and the second string B are positioned at different locations, i.e., if the matching characters are transposed. The determination is made only if the character match counter (max_h) is greater than the minimum number of matching characters (M). A set of conditions (if (pa<g and pb>=p or pb<p and pa>=g) or g in (pa, pa+max_h] or p in (pb, pb+max_h])) are defined which check if the matching one or more characters in string A and string B are transposed. As shown, the conditions compare the position of the first matching character in string A (pa) and the position of the first matching character in string B with variables g and p of the transposition_gestalt function. If any of the defined condition is satisfied the value of number of transpositions (T, ret [0]) is incremented by 1. In the above example, the value of the character match counter (max_h) 6 is greater than the value of the minimum number of matching characters (M) 3. The value of pa, pb, g, and p are 0, 5, 0, and 0, respectively. In the above example, all the conditions are false (pa(0)<g(0) and pb(5)>=p(0):false; pb(5)<p(0) and pa(0)>=g(0):false; g(0) in (pa(0), pa(0)+max_h(6)]:false; and p(0) in (pb(5), pb(5)+max_h(6)]:false) therefore the value of ret[0] is not incremented. The variable ret [1] [ret [0]] which provides the value of the number of transpositions and the character match counter is incremented by the character match counter (max_h). In the above example the variable ret[1] [ret[0]] is incremented by 6 to obtain a value [0, 6], i.e., the number of transpositions is 0 and the character match counter is 6 when the number of transpositions is 0.

Finally at portion 1008 of the code the transposition_gestalt function is invoked again. In one embodiment, the matching one or more characters in string A and string B are removed from both the strings A and B to obtain A′ (A′=A [0 . . . pa]+A [pa+max_h . . . m]) and B′ (B′=B [0 . . . pb]+B [pb+max_h . . . n]), respectively. The position of the first matching character in string A incremented by 1, i.e., pa+1 is assigned to g and the position of the second matching character in string B incremented by 1, i.e., pb+1 is assigned to p. The transposition_gestalt function is then invoked again with A′ and B′, pa+1, pb+1, and the number of transpositions (transposition_gestalt (A′, B′, pa+1, pb+1, M, ret [0]). In the above example, the value of A′ is “<space>MAIN” and B′ is “MAIN<space>” after removing the matching characters “STREET” from string A and B, respectively. The value of pa+1 and pb+1 are 1 and 6, respectively and the number of transpositions is 0. The transposition_gestalt function is therefore invoked with the values (“MAIN”, “MAIN” 1, 6, 3, 0).

The second time the transposition_gestalt function is invoked the variables i, j, h, and max_h are again set to 0. The value of m and n are 4. The value of g is 1 (pa+1) and the value of p is 6 (pb+1).

Next, the nested loops in portion 1004 of the code is executed again, When the portion 1004 is executed again the character match counter (max_h) has a value of 4 as there are four matching characters in “MAIN”, the position pa of first matching character M in string A′ is 1 as there is <space> before the string A′, and the position pb of the first matching character M in pb is 0. When the portion 1006 of the code is executed, the character matching counter M (4) is greater than the minimum number of matching characters 3. Therefore, the conditions for determining the transposition are checked. In this case, the condition, pb (0)<p (6) and pa (1)>=g(1), for determining the transposition is true. Therefore, the variable ret[0] that indicates the number of transposition is incremented by 1.

Finally, the variable ret[1][ret[0]] provides the number of transposition and the character match counter corresponding to the number of transpositions {1, (6, 4)}, i.e., the number of transpositions is 1, the character match counter when the number of transposition is 0 is 6, and the character match counter when the number of transposition is 1 is 4.

This obtained character match counter and the number of transpositions may then be used for computing the matching and transposition score for each of the plurality of partial address.

As discussed above, the partial address having the highest maximum and transposition score is determined as the best matching candidate. After the best matching candidate is determined, the geocoding database is queried with the best matching candidate to obtain geocoding information related to the input address. As discussed above, the geocoding database stores the reference data, i.e., the plurality of addresses and the geocoding information related to the plurality of addresses. The geocoding database stores each of the plurality of addresses at a separate memory address, from among the plurality of memory addresses, in the geocoding database. When the geocoding database is queried the plurality of memory addresses are to be read for fetching the address, which matches with the best matching candidate, from the geocoding database.

The geocoding database stores the plurality of addresses, of the reference data, alphabetically in the memory addresses of the geocoding database. However, storing the addresses alphabetically may decrease the performance of the geocoding application if two addresses which can be grouped together are stored at two memory addresses which are far apart from each other. In this case, if the geocoding database is queried each memory address between the memory addresses storing the two addresses which can be grouped together have to be read for fetching the two related addresses. Therefore, the addresses stored in the geocoding database are to be re-arranged such that the address, matching with the best matching candidate, may be fetched from the geocoding database by reading the minimum number of memory addresses.

In one embodiment, a set of assumptions are defined for re-arranging the plurality of addresses stored in the geocoding database. The first assumption is that the portion of the address that has maximum number of characters is assumed to contain the most important information about the address. The second assumption is if two portions of the address have the same length then the first portion, i.e., the portion of the address which is positioned at the beginning of the address, is more important. The third assumption is that the portion of the address that may have alternatives, for example “STREET” has an alternative “ST”, contain less important information.

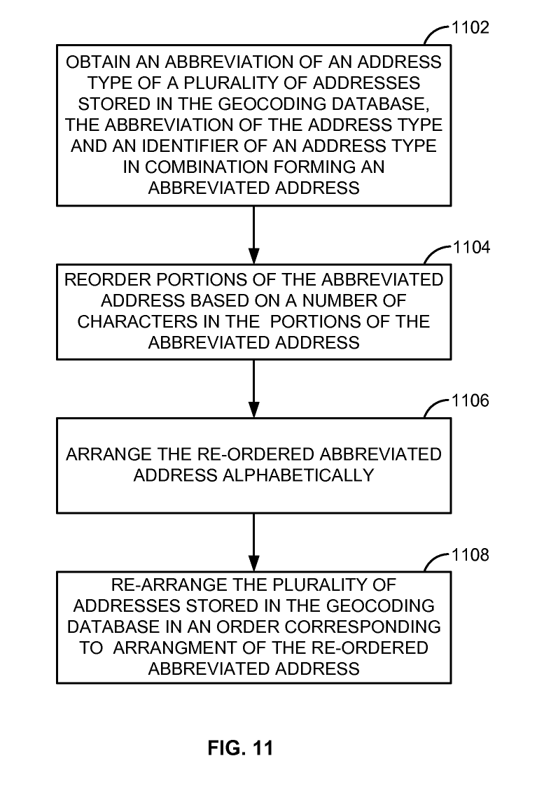

FIG. 11 is a flow diagram illustrating a method for re-arranging the plurality of addresses stored in the geocoding database, according to an embodiment. In one embodiment, the plurality of addresses are re-arranged in the geocoding database at design time.

Initially at block 1102 an abbreviation of an address type of the plurality of addresses stored in the geocoding database is obtained. In one embodiment, the abbreviation is obtained for the address type of each of the addresses stored in the geocoding database.

In one embodiment, each of the plurality of addresses stored in the geocoding database includes an address type and an identifier of the address type. The address type of the address provides information about the type of the address. For example, the address type of the address may be “STREET”, “ROAD”, and “AVENUE” which provides the information that the address is a “STREET”, a “ROAD”, or an “AVENUE”.

In one embodiment, the abbreviation for the address type of the address provides an abbreviated form of the address type. For example, if the address type of an address is “AVENUE”, the abbreviation for the address type is “AV”.

The identifier of the address type identifies the address and distinguishes the address from other addresses stored in the geocoding database. In one embodiment, the identifier of the address type may be a street name which identifies the street. For example, if the address is “AVENUE JOHN”, the address type of the address is “AVENUE” and the identifier of the address type is “JOHN”.

In one embodiment, the obtained abbreviation of the address type and the identifier of the address type are combined to form an abbreviated address corresponding to each of the plurality of addresses stored in the geocoding database. In the above example of “AVENUE JOHN”, the abbreviation “AV” of the address type “AVENUE” is combined with the identifier of the address type “JOHN” to obtain the abbreviated address “AV JOHN” corresponding to the address “AVENUE JOHN”.

Next at block 1104 portions of the abbreviated address is reordered based on a number of characters in the portions of the abbreviated address. In one embodiment, the portions of the abbreviated address are reordered such that the portion having the maximum number of characters in the abbreviated address is positioned at a beginning of the abbreviated address. In the above example, the portion “JOHN” of the abbreviated address “AV JOHN” has maximum number of characters. Therefore, the abbreviated address “AV JOHN” is re-ordered to “JOHN AV”.

In one embodiment, an abstraction operation is performed on the re-ordered abbreviated address to obtain the abstract re-ordered abbreviated address. In the above example, the abstract re-ordered abbreviated address is “JNAV” correponding to the re-ordered abbreviated address “JOHN AV”.

Next at block 1106, the obtained re-ordered abbreviated addresses are arranged alphabetically. In one embodiment, the re-ordered abbreviated addresses are arranged alphabetically based on a first character of the re-ordered abbreviated addresses. In one embodiment, the abstract re-ordered abbreviated addresses are arranged alphabetically based on the first character of the abstract re-ordered abbreviated address.

Finally at block 1108, the plurality of addresses stored in the geocoding database are re-arranged in an order corresponding to arrangement of the re-ordered abbreviated address. In one embodiment, the plurality of addresses stored in the geocoding database are re-arranged in an order corresponding to the arranged abstract re-ordered abbreviated address.

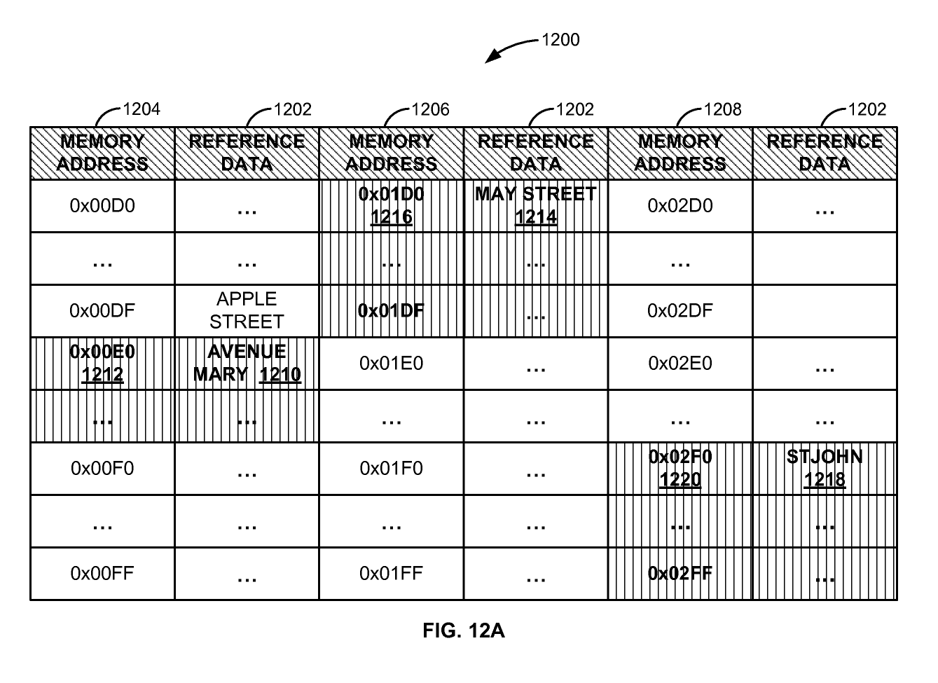

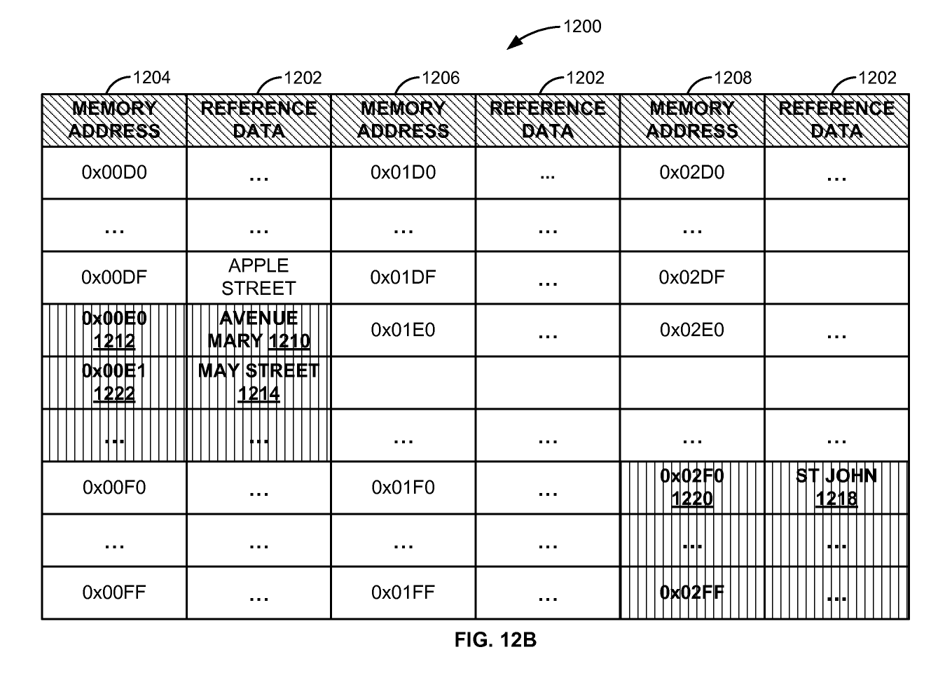

FIG. 12A illustrates an exemplary geocoding database 1200, according to an embodiment. As discussed above, the geocoding database 1200 stores the reference data 1202. The reference data 1202 may include a plurality of addresses and geocoding information. In one embodiment, the geocoding database 1200 includes a plurality of memory addresses and the reference data is stored in the plurality of memory addresses in the geocoding database 1200. As shown, the geocoding database 1200 includes three blocks of memory addresses 1204, 1206, and 1208, where each block has OXF memory address. The reference data 1202 includes an address “AVENUE MARY” 1210 stored at memory location 1212 of memory address block 1204, an address “MAY STREET” 1214 stored at memory location 1216 of memory address block 1206, and an address “ST JOHN” 1218 at memory location 1220 of memory address block 1208.

The address type of the address “AVENUE MARY” 1210 is “AVENUE” and the identifier of the address type is “MARY”, the address type of the address “MAY STREET” 1214 is “STREET” and the identifier of the address type 1214 is “MAY”, and the address type of the address “ST JOHN” is “ST” which is an acronym for “STREET” and the identifier of the address type is “JOHN.”

The address “AVENUE MARY” 1210 and “MAY STREET” 1214 can be grouped together as the identifier of the address type “AVENUE MARY” 1210, i.e., “MARY” and the identifier of the address “MAY STREET” 1214, i.e., “MAY” are similar to each other. Further, the address “ST JOHN” 1218 and “MAY STREET” 1214 are related because the longest portion of the address “MAY STREET” 1214, i.e., “STREET” and its abbreviation, i.e., “ST” in “ST JOHN” 1218 is same. When the geocoding database 1200 is queried with the best matching candidate, which matches with one of these addresses which may be grouped together, three blocks of memory addresses 1204, 1206, and 1208 have to be read for fetching these addresses from the geocoding database 1200. This considerably decreases the performance of the geocoding application.

Therefore, the geocoding database 1200 is re-arranged such that the addresses 1210, 1214, and 1218, which may be grouped together, are fetched from the geocoding database 1200 with as less memory read as possible.

As discussed above, for re-arranging the plurality of addresses initially the abbreviation of the address type of the plurality of addresses 1210, 1214, and 1218 stored in the geocoding database 1200 is obtained. The abbreviation for the address type “AVENUE” of the address “AVENUE MARY” 1210 is “AV”, the abbreviation for the address type “STREET” of the address “MAY STREET” 1214 is “ST”, the address type of the address “ST JOHN” 1218, i.e., “ST” is the abbreviation for “STREET” and is therefore not changed.

The abbreviation “AV” is combined with the identifier of the address type “MARY” to obtain the abbreviated address “AV MARY” corresponding to the address “AVENUE MARY” 1210, the abbreviation “ST” is combined with the identifier of the address type “MAY” to obtain the abbreviated address “MAY ST” corresponding to the address “MAY STREET” 1214. As discussed above the address type of the address “ST JOHN”, i.e., “ST” is already in abbreviated form, therefore the abbreviated address for “ST JOHN” is “ST JOHN” 1218.

Next portions of the abbreviated address are reordered based on a number of characters in the portions of the abbreviated address. The portion “MARY” of the abbreviated address “AV MARY” has maximum number of characters. Therefore, the abbreviated address “AV MARY” is re-ordered to “MARY AV”. Similarly, the address “ST JOHN” and “MAY ST” are reordered to “JOHN ST” and “MAY ST”, respectively. After the re-ordering of the abbreviated addresses the re-ordered abbreviated addresses are “MARY AV”, “JOHN ST”, and “MAY ST”.

In one embodiment, the abstract re-ordered abbreviated address correponding to the re-ordered abbreviated address is obtained. The obtained abstract re-ordered abbreviated address correponding to the re-ordered abbreviated address “MARY AV” is “MRYAV”, correponding to the re-ordered abbreviated address “JOHN ST” is “JN ST”, and corresponding to the re-ordered abbreviated address“MAY ST” is “MYST”.

Next, the obtained abstract re-ordered abbreviated addresses are arranged alphabetically. The abstract re-ordered abbreviated address “MRYAV”, “JNST”, and “MYST” are arranged alphabetically based on the initial one or more characters are MR, JN, and MY, respectively. The arranged abstract re-ordered abbreviated addresses obtained are “MRYAV”, “MYST”, and “JNST”.

Finally, the plurality of addresses 1210, 1214, and 1218 stored in the geocoding database 1200 are re-arranged in an order corresponding to arrangement of the abstract re-ordered abbreviated address “MRYAV”, “MYST”, and “JNST”. After obtaining the arranged abstract re-ordered abbreviated addresses it is realized that the address “AVENUE MARY” 1210 and “MAY STREET” 1214 corresponding to “MRYAV” and “MYST”, respectively, can be grouped together. In one embodiment, the addresses that can be grouped together are stored in nearby memory locations.

FIG. 12B illustrates the exemplary geocoding database 1200 of FIG. 12A storing the re-arranged plurality of addresses, according to an embodiment. As shown in FIG. 12B, the address “AVENUE MARY” 1210 and “MAY STREET” 1214, which can be grouped together, are stored in adjacent memory addresses 1212 and 1222 of the memory address block 1204. This ensures that only two memory addresses are to be read when the geocoding database is queried with the best matching candidate matching. This may provide an improvement in the performance of the geocoding application.

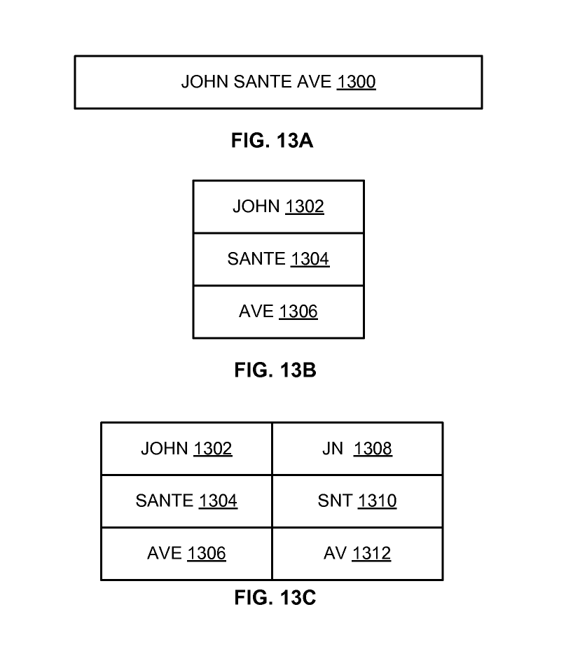

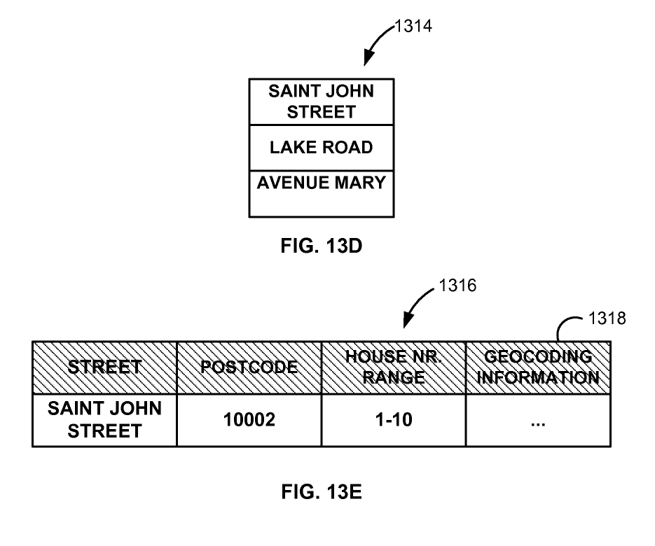

FIGS. 13A illustrate an exemplary input address whose geocoding information is to be determined, according to an embodiment. As shown, the input address 1300 is “JOHN SANTE AVE”. In one embodiment, the input address 1300 is received from a user.

FIGS. 13B-13C illustrates portions of the input address of FIG. 13A obtained after performing lexical analysis on the input address 1300 of FIG. 13A, according to an embodiment. The lexical analysis performed on the input address “JOHN SANTE AVE” 1300 is the parsing operation followed by the abstraction operation. The parsing operation parses the input address “JOHN SANTE AVE” 1300 at the white spaces to obtain three portions “JOHN” 1302, “SANTE” 1304, and “AVE” 1306 of the input address “JOHN SANTE AVE” 1300.

The abstraction operation is then performed on the obtained portions “JOHN” 1302, “SANTE” 1304, and “AVE” 1306 obtained after the parsing operation. As shown in FIG. 13C, the abstraction obtained for the portion “JOHN” 1302 is “JN” 1308, the abstraction obtained for the portion “SANTE” 1304 is “SNT” 1310, and the abstraction obtained for the portion “AVE” 1306 is “AV” 1312.

After obtaining the abstraction 1308, 1310, and 1312 of the portions 1302, 1304, and 1306 of the input address 1300, fuzzy searching is performed on the knot-sequence tree 500 of FIG. 5B to identify the plurality of partial addresses stored in the knot-sequence tree 500 that are fuzzy matches of the input address “JOHN SANTE AVE” 500. In one embodiment, fuzzy searching on the knot-sequence tree 500 is performed by comparing the first character of each of the abstraction “JN” 1308, “SNT” 1310, and “AV” 1312 with the first character of the information stored in the parent nodes 502-514 of the knot-sequence tree 500. In one embodiment, the first character of the abstraction “JN” 1308, “SNT” 1310, and “AV” 1312 are compared with the first character of the information stored in the parent nodes 602-614 of the abstraction knot-sequence tree 600.

The first character of the abstraction “JN” 1308 matches with the first character of the information “JOHN” stored in the parent node 508 of the branch sequence 534 (FIG. 5B). Therefore, the branch sequence 534 is traversed to identify the partial address “SAINT JOHN STREET”, stored in the branch sequence information block 570 associated with the branch sequence 534, as one of the possible matches for the input address “JOHN SANTE AVE” 1300.

The first character of the portion “AV” 1312, i.e., “A” matches with the first character of the information “AVENUE” stored in the parent node 514 of the branch sequence 540 (FIG. 5B). The branch sequence 540 is traversed to identify the partial address “AVENUE MARY” stored in the branch sequence information block 574 associated with the branch sequence 540, as one of the possible matches for the input address “JOHN SANTE AVE” 1300. As the branch sequence information block 574 storing the identified partial address “AVENUE MARY” refers to the branch sequence information block 572 which stores the address “LAKE ROAD”. Therefore, the address “LAKE ROAD” is also one of the identified partial addresses for the input address “JOHN SANTE AVE” 1300.

The first character “S” of the portion “SNT” 1310 matches with the information “S” stored in the parent node 504 (FIG. 5B). As shown in FIG. 5B, the parent node 504 storing “S” has two child nodes 550 and 554 storing “AINT” and “TREET”, respectively. Therefore, an abstraction of the combination of information stored in the parent node and the child node is obtained. The abstraction of the combination of information stored in the parent node 504 “S” and the child node 550 “AINT”, i.e., “SAINT” is “SNT”. The abstraction of the combination of information stored in the parent node 504 “S” and the child node 550 “AINT”, i.e., “SAINT” is “SNT”.

Both the obtained abstraction of the combination of information, i.e., “SNT” and “STRT” are compared with the portion “SNT” 1310 of the input address 1300. As the abstraction of the combination of information “SNT”, stored in the parent node 504 and child node 550 of the branch sequence 520, matches with the portion “SNT” 1310 of the input address 1300, the branch sequence 520, including the parent node 504 and the child node 550, is traversed. The partial address “SAINT JOHN STREET” stored in the branch sequence information block 570 associated with the branch 520 is identified as one of the partial addresses for the input address “JOHN SANTE AVE” 1300.

FIG. 13D illustrates a matching partial address list 1314 of identified partial addresses for the input address 1300 of FIG. 13A, according to an embodiment. As shown, the list 1314 includes the identified partial address “SAINT JOHN STREET”, “LAKE ROAD”, and “AVENUE MARY” obtained by fuzzy searching the knot-sequence tree.

Next the matching and transposition score is computed for each of the identified partial addresses “SAINT JOHN STREET”, AVENUE MARY”, and “LAKE ROAD”. The matching and transposition score computed for “SAINT JOHN STREET”, AVENUE MARY”, and “LAKE ROAD” is 0.5290, 0.24, and 0, respectively.

Based on the computed matching and transposition score the identified partial address “SAINT JOHN STREET”, which has the highest score, is identified as the best matching candidate.

Finally, the geocoding database is queried with the best matching candidate to obtain the geocoding information related to the input address 1300 of FIG. 13A.

FIG. 13E illustrates a portion of the reference data 1316 stored in the geocoding database, according to an embodiment. As shown the portion of reference data includes the best matching candidate “SAINT JOHN STREET” and the geocoding information 1318 related to the best matching candidate “SAINT JOHN STREET”. The geocoding information 1318 related to the best matching candidate is the geocoding information of the input address 1300 “JOHN SANTE AVE”. The geocoding information 1318 is retrieved from the geocoding database and provided to the user.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

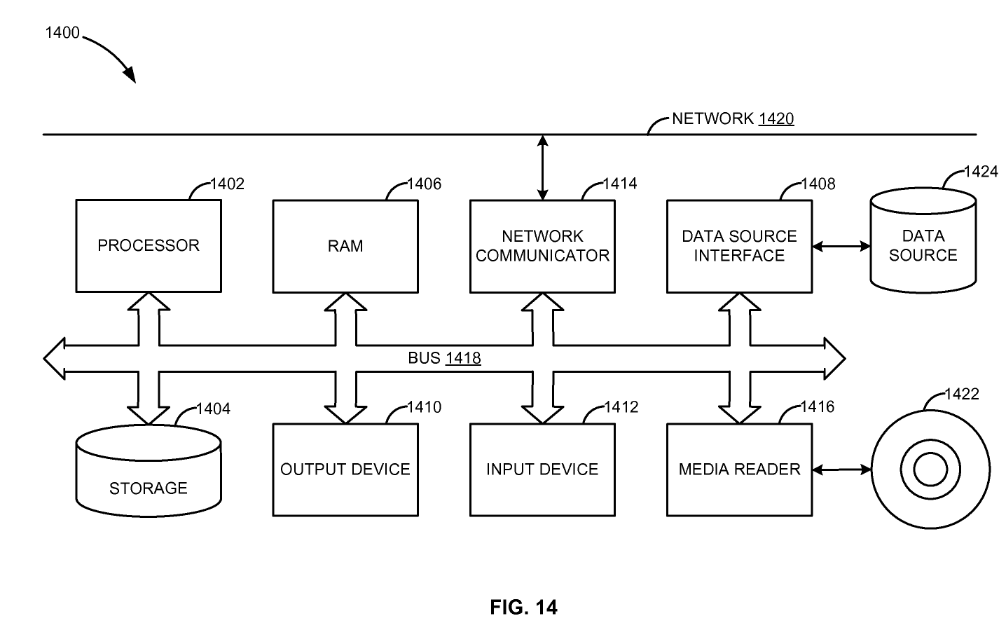

FIG. 14 is a block diagram of an exemplary computer system 1400. The computer system 1400 includes a processor 1402 that executes software instructions or code stored on a computer readable storage medium 1422 to perform the above-illustrated methods of the invention. The computer system 1400 includes a media reader 1416 to read the instructions from the computer readable storage medium 1422 and store the instructions in storage 1404 or in random access memory (RAM) 1406. The storage 1404 provides a large space for keeping static data where at least some instructions could be stored for later execution. The stored instructions may be further compiled to generate other representations of the instructions and dynamically stored in the RAM 1406. The processor 1402 reads instructions from the RAM 1406 and performs actions as instructed. According to one embodiment of the invention, the computer system 1400 further includes an output device 1410 (e.g., a display) to provide at least some of the results of the execution as output including, but not limited to, visual information to users and an input device 1412 to provide a user or another device with means for entering data and/or otherwise interact with the computer system 1400. Each of these output devices 1410 and input devices 1412 could be joined by one or more additional peripherals to further expand the capabilities of the computer system 1400. A network communicator 1414 may be provided to connect the computer system 1400 to a network 1420 and in turn to other devices connected to the network 1420 including other clients, servers, data stores, and interfaces, for instance. The modules of the computer system 1400 are interconnected via a bus 1418. Computer system 1400 includes a data source interface 1408 to access data source 1424. The data source 1424 can be accessed via one or more abstraction layers implemented in hardware or software. For example, the data source 1424 may be accessed by network 1420. In some embodiments the data source 1424 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method for a geocoding application, the method comprising:
performing a lexical analysis on an input address to obtain portions of the input address;
fuzzy searching a knot-sequence tree with the obtained portions of the input address for identifying one or more of a plurality of partial addresses stored by the knot-sequence tree;
computing a matching and transposition score for the identified one or more of the plurality of partial addresses to determine a best matching candidate from among the identified one or more of the plurality of partial addresses; and
querying a geocoding database with the best matching candidate to obtain geocoding information related to the input address.

2. The computer implemented method according to claim 1, wherein the lexical analysis comprises a parsing operation that splits the input address into the portions of the input address according to language of the input address.

3. The computer implemented method according to claim 1, wherein the lexical analysis comprises an abstraction operation, and wherein fuzzy searching the knot sequence tree further comprises:
determining an abstraction of the input address and information stored in a parent node of the knot-sequence tree; and
comparing the abstraction of the input address with the abstraction of the information stored in the parent node.

4. The computer implemented method according to claim 1, wherein the lexical analysis comprises a stretch operation, and wherein the stretch operation expands a plurality of characters of the input address according to language of the input address.

5. The computer implemented method according to claim 1, wherein fuzzy searching the knot-sequence tree includes comparing the obtained portions of the input address with information stored in a parent node of the knot-sequence tree.

6. The computer implemented method according to claim 5, wherein the one or more of the plurality of partial addresses are identified if a first character of at least one of the portions of the input address matches with a first character of the information stored in the parent node.

7. The computer implemented method according to claim 5, wherein the parent node is a root node of a branch sequence of the knot-sequence tree, wherein the branch sequence is associated with a sequence information block of the knot-sequence tree, and wherein the sequence information block is storing at least one of the plurality of partial addresses.

8. The computer implemented method according to claim 7, wherein the sequence information block refers to another sequence information block, and wherein computing the matching and transposition score for the identified plurality of partial addresses, further comprises:
comparing the input address with one of the plurality of partial addresses stored in the sequence information block and one of the plurality of partial addresses stored in the another sequence information block.

9. The computer implemented method according to claim 7, wherein a child node of the branch sequence is connected to the parent node by a branch that indicates a direction for traversing the branch sequence.

10. The computer implemented method according to claim 9, further comprising:
comparing the obtained portions of the input address with a combination of information stored in the parent node and the child node.

11. The computer implemented method according to claim 1, wherein the plurality of partial addresses stored by the knot-sequence tree matches with a plurality of addresses stored in the geocoding database.

12. The computer implemented method according to claim 1, wherein the input address includes a plurality of address components.

13. The computer implemented method according to claim 1, wherein computing the matching and transposition score for the identified one or more of the plurality of partial addresses further comprises:
comparing a plurality of characters in an identified partial address, from among the identified plurality of partial addresses, with a plurality of characters in the input address, to match one or more characters in the identified partial address and the input address;
incrementing a character match counter for each match determined;
based on the comparison, determining if a position of the matching one or more characters in the identified partial address and the input address are different;
determining a number of transpositions required to re-arrange the position of the matching one or more characters in the identified partial address, such that the position of the matching one or more characters in the identified partial address and the input address is same; and
using the character match counter and the number of transpositions to compute the matching and transposition score for the identified partial address.

14. The computer implemented method according to claim 1, further comprising:
identifying a common character in a plurality of words of a plurality of addresses stored in the geocoding database;
storing the identified common character in a parent node of the knot-sequence tree, the identified common character being information stored in the parent node, the parent node being a root node of a branch sequence of the knot-sequence tree;
storing a remaining portion of a word, from among the plurality of words, associated with the common character in a child node of the branch sequence, the child node and the parent node being connected by a branch that indicates a direction for traversing the branch sequence; and
storing the plurality of partial addresses in a sequence information block associated with the branch sequence.

15. The computer implemented method according to claim 1, wherein a plurality of addresses stored in the geocoding database has an address type and an identifier of the address type, the plurality of addresses stored in the geocoding database being re-arranged at least based on the identifier of the address type.

16. The computer implemented method according to claim 15, further comprising:
obtaining an abbreviation of the address type of the plurality of addresses, the abbreviation of the address type and the identifier of the address type in combination forming an abbreviated address;
re-ordering portions of the abbreviated address based on a number of characters in the portions of the abbreviated address;
arranging the re-ordered abbreviated address alphabetically; and
re-arranging the plurality of addresses stored in the geocoding database in an order corresponding to arrangement of the re-ordered abbreviated address.

17. An article of manufacture including a computer readable storage medium to tangibly store instructions, which when executed by a computer, cause the computer to:
perform a lexical analysis on an input address to obtain portions of the input address;
fuzzy search a knot-sequence tree with the obtained portions of the input address to identify one or more of a plurality of partial addresses stored by the knot-sequence tree;
compute a matching and transposition score for the identified one or more of the plurality of partial addresses to determine a best matching candidate from among the identified one or more of the plurality of partial addresses; and
query a geocoding database with the best matching candidate to obtain a geocoding information related to the input address.

18. The article of manufacture according to claim 17, wherein fuzzy searching the knot-sequence tree includes comparing the obtained portions of the input address with information stored in a parent node of the knot-sequence tree.

19. The article of manufacture according to claim 18, wherein the one or more of the plurality of partial addresses are identified if a first character of at least one of the portions of the input address matches with a first character of the information stored in the parent node.

20. The article of manufacture according to claim 18, wherein the parent node is a root node of a branch sequence of the knot-sequence tree, and wherein the branch sequence is associated with a sequence information block storing at least one of the plurality of partial addresses.

21. The article of manufacture according to claim 20, wherein the sequence information block refers to another sequence information block, and wherein the article of manufacture further comprises instructions which when executed by the computer further causes the computer to:
compare the input address with one of the plurality of partial addresses stored in the sequence information block and one of the plurality of partial addresses stored in the another sequence information block.

22. The article of manufacture according to claim 20, wherein a child node of the branch sequence is connected to the parent node by a branch that indicates a direction for traversing the branch sequence.

23. The article of manufacture according to claim 22, further comprising instructions which when executed by the computer further causes the computer to:
compare the obtained portions of the input address with a combination of information stored in the parent node and the child node.

24. A computer system for implementing a geocoding application, the computer system comprising:
a memory to store a program code; and
a processor communicatively coupled to the memory, the processor configured to execute the program code to:
perform a lexical analysis on an input address into to obtain portions of the input address;
fuzzy search a knot-sequence tree with the obtained portions of the input address to identify one or more of a plurality of partial addresses stored by the knot-sequence tree;
compute a matching and transposition score for the identified one or more of the plurality of partial addresses to determine a best matching candidate from among the identified one or more of the plurality of partial addresses; and
query a geocoding database with the best matching candidate to obtain geocoding information related to the input address.

25. The computer system according to claim 24, wherein fuzzy searching the knot-sequence tree includes comparing the obtained portions of the input address with information stored in a parent node of the knot-sequence tree.

26. The computer system according to claim 25, wherein the one or more of the plurality of partial addresses are identified if a first character of at least one of the portions of the input address matches with a first character of the information stored in the parent node.

27. The computer system according to claim 25, wherein the parent node is a root node of a branch sequence of the knot-sequence tree, and wherein the branch sequence is associated with a sequence information block storing at least one of the plurality of partial addresses.

28. The computer system according to claim 27, wherein the sequence information block refers to another sequence information block, and wherein the processor further executes the program code to:
compare the input address with one of the plurality of partial addresses stored in the sequence information block and one of the plurality of partial addresses stored in the another sequence information block.

29. The computer system according to claim 27, wherein a child node of the branch sequence is connected to the parent node by a branch that indicates a direction for traversing the branch sequence.

30. The computer system according to claim 29, wherein the processor further executes the program code to:
compare the obtained portions of the input address with a combination of information stored in the parent node and the child node.
